(19) United States
(12) Patent Application Publication
(10) Pub. No.: US 2014/0170623 A1
(43) Pub. Date: Jun. 19, 2014

(54) CATARACT SURGICAL TRAINER

(71) Applicants: John S. Jarstad, Federal Way, WA (US); Paul R. Stone, Federal Way, WA (US)

(72) Inventors: John S. Jarstad, Federal Way, WA (US); Paul R. Stone, Federal Way, WA (US)

(21) Appl. No.: 13/719,410

(22) Filed: Dec. 19, 2012

(51) Int. Cl. G09B 23/30

(52) U.S. Cl. CPC G09B 23/30
USPC 434/267

(57) ABSTRACT

The invention could be a surgical cataract trainer and a process for constructing same comprising an artificial surgical practice media formed from malleable material and two polymer sheets; a holder comprising of a base and a column with two ends, the base attaches to one end while the other end is open and is shaped to receive at least a portion of the artificial surgical practice media; a retaining ring; wherein one polymer sheet is stretched over the open end to support the malleable material within the open end as the other polymer sheet drapes over the malleable material, the one polymer sheet and the column to sandwich the malleable material between the two polymer sheets, the ring receives the two polymer sheets together with an outside of the column to make the polymer sheets taunt relative to the open end.

### STATEMENT REGARDING FEDERALLY SPONSORED RESEARCH OR DEVELOPMENT

Not Applicable.

### REFERENCE TO A “MICROFICHE APPENDIX”

Not Applicable.

### FIELD OF THE INVENTION

The present invention relates to those optical surgery training devices that can mimic the features of an eye lens within an eye. More particularly to those devices that provide training for the removal and replacement of an eye lens from within an eye.

### BACKGROUND

Through an aging, disease or injury, the lens of the human eye may become cloudy enough to substantially impair the transmission of external light through the lens to the retina, where the light creates the nerve signals that are subsequently processed by the brain to create visual images as recognized by the individual. This clouded portion of the lens is generally known as a cataract and depending on its light transmission impairment, this condition may lead to such visual impairments such as: significant vision loss; cloudy or fuzzy vision; loss of color intensity; double vision; impairment of night vision; difficulty in seeing shapes against a background; difficulty in seeing differences between shades of colors and the like.

The medical remediation for such a condition may be a surgical removal of the afflicted lens with a subsequent surgical insertion of an artificial lens that restores the visual capacity of the eye. Due to the delicate nature of the eye structure, the surgical procedure for lens replacement does not tolerate well any mishaps for the incisions; removal of the occluded lens or insertion of artificial lens. As such, surgeons learning cataract removal/lens replacement surgical procedure(s) generally need to repeatedly practice on appropriate (e.g., non-patient) surgical practice media to ensure they are thoroughly well-versed in their physical surgical movements and thoroughly invested in their working knowledge of the procedure. Generally, such surgical practice media includes real tissue animal eyes (e.g., such as pig eyes as harvested through the meat process industry) and artificial practice media that may include artificial eyes that are carefully constructed to realistically mimic the physical characteristics of the human eye for surgical purposes. These various versions of surgical practice media may have some drawbacks in that they may be seen as expensive to procure, which subsequently may limit how often they can be used to practice cataract surgical procedures. The real tissue surgical practice media may have additional limitations in that in some cultures, the use of the real tissue practice media, such as pig tissue, may be against religious practices. Further, real tissue practice media may have to be used immediately as it generally cannot be stored; may represent a biohazard and have an added expense for their disposal.

What could be needed is a cataract surgical trainer that utilizes an artificial surgical practice media held in an open end of a column supported upright by a base. The overall setup and materials involved could provide for simple, inexpensive and rapid reutilization of the invention using common everyday items.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a cataract surgical trainer wherein the artificial surgical practice media could be a disc or ball of clay sandwiched between two polymer sheets;

the ability to create a simple and cost effective cataract surgical trainer from inexpensive and commonly found materials;

to provide a cataract surgical trainer wherein a ball of modeling sandwiched in between two polymer sheets is used to simulate the cataract;

the ability to use cellophane to simulate the posterior and anterior capsule membranes of the human eye;

to provide a ring that slides upon a column to hold artificial surgical practice material in place at an open end of the column to substantially eliminate the need for the operator to hold the artificial surgical practice media in place; and

the ability to allow the operator to use both hands in practicing on the invention by not requiring the operator to hold the artificial surgical practice media in place upon the column.

These and other advantages may be realized by reference to the remaining portions of the specification, claims, and abstract.

### Brief Description of One Embodiment of the Present Invention

One possible embodiment of the invention could be a surgical cataract trainer comprising an artificial surgical practice media formed from malleable material and two polymer sheets; media holder comprising of a base and a column with two ends, the base attaches to one end while the other end is open and can receive at least a portion of the artificial surgical practice media; a retaining ring; wherein one polymer sheet is stretched over the open end to support the malleable material within the open end as the other polymer sheet drapes over the malleable material, the one polymer sheet and the column to sandwich the malleable material between the two polymer sheets, the ring fits over (e.g., receives) and constricts against the two polymer sheets together with an outside of the column to make the polymer sheets taut relative to the open end.

One possible embodiment of the invention could be a process for constructing a cataract surgical trainer comprising of the following steps, but not necessarily in the order shown of providing an artificial surgical practice media of a malleable material and two polymer sheets; providing a media holder of a base and a column with two ends, the base attaching to one end while the other end is open, concave and can receive at least a portion of the artificial surgical practice media; providing a retaining ring; placing one polymer sheet over the open end; creating a depression in the one polymer sheet within the open end; forming the malleable material into a ball; placing the malleable material into the depression; draping the other polymer sheet over the malleable material, the one polymer sheet and the column causing the malleable material to be sandwiched between the two polymer sheets; and placing column and two polymer sheets within the retaining ring to hold the malleable material tautly between the two polymer sheets.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective cutaway view of one embodiment of the present invention.

FIG. 2 is substantially a perspective view of one embodiment of the media holder of the present invention.

FIG. 3 is substantially an elevation cutaway view of one embodiment of the media holder supporting artificial surgical practice media of the present invention.

FIG. 4 is substantially a perspective view of the retaining ring of the present invention.

FIG. 5 is substantially a lateral cutaway view of one embodiment of the retaining ring of the present invention.

FIG. 6 is substantially a cutaway view of one embodiment of mask of the present invention.

FIG. 7 is substantially schematic flow chart for of one embodiment of process or method for assembling the present invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

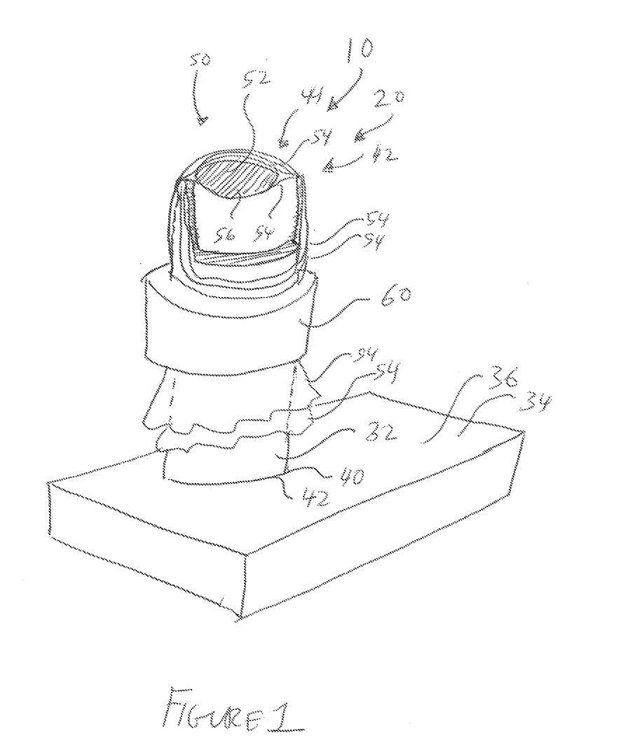

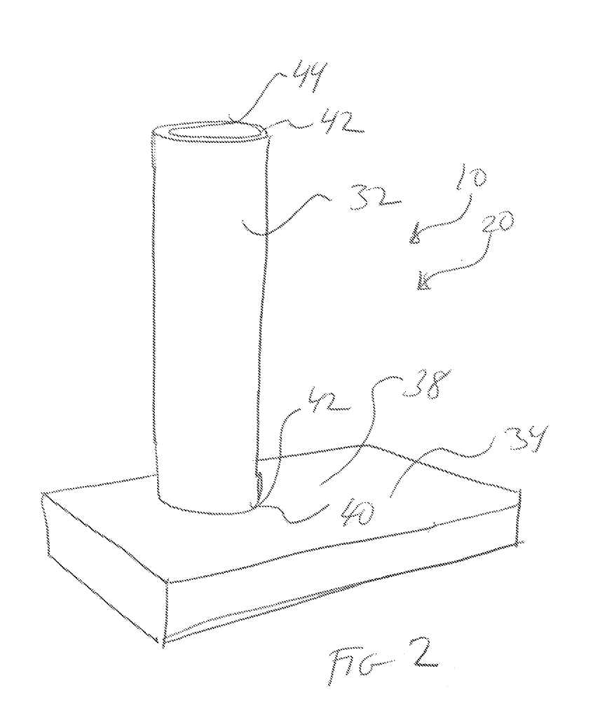

The present invention 10 could comprise a cataract surgical trainer 20 and a method or process of assembly of same 100. As substantially shown in FIG. 1, the cataract surgical trainer 20 could comprise of a media holder 30, a retaining ring 66, and an artificial surgical practice media 50. The retaining ring 66 could hold an artificial surgical practice media 50 taunt upon the media holder 30. As substantially shown in FIG. 2, the media holder 30 in at least one embodiment could comprise at least of one double-ended column 32 and base 34. In at least one embodiment, the column 32 could be a double open-ended hollow tube (e.g., made from ½ inch polyvinyl chloride [PVC] pipe.) In another embodiment, the column 32 could be substantially a solid rod with one of its ends slightly hollowed out (e.g., concave) and open to receive at least a portion of the artificial surgical practice media 50.

The base 34 could be a rectangular plate 36 of a suitable material and a construction substantial enough to generally hold column(s) 32 attached to it in an upright position. The base 34 could have on its top side 38 one (or more) recesses 40 into which an end 42 of the column 32 could be anchored (e.g., suitably by glue, fastener or other such attachment means.) In this manner, the other unattached open end (e.g., concave) 46 of the column 32 could be held distal from the base 34 to be used to support the artificial surgical practice media 50 (as substantially shown in FIG. 2.)

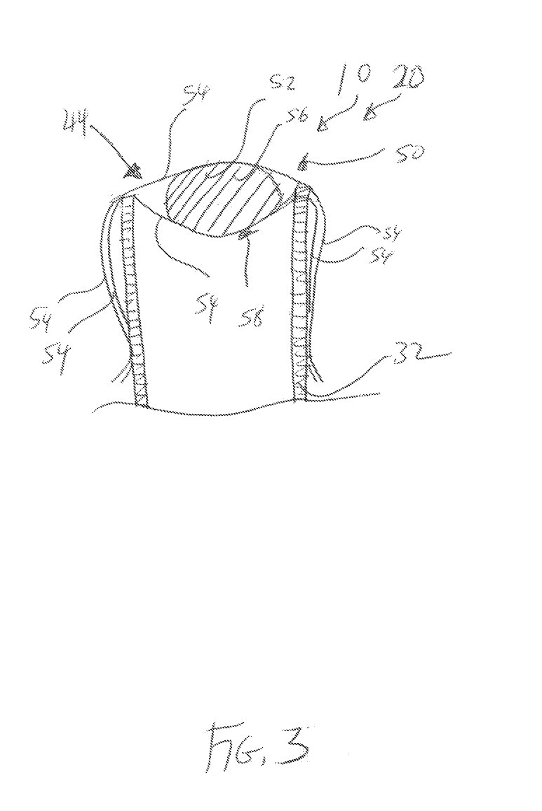

As substantially shown in FIG. 3, the artificial surgical practice media 50 could comprise of a malleable material 52 and two polymer sheets 54. The malleable material 52 in one embodiment could be modeling clay. The modeling clay could include a wide variety of materials such as ceramic clays (e.g., water-based substances made from clay minerals and combined with other raw materials), oil-based clays (e.g., made from combinations of oils, waxes and clay materials), polymer clay (e.g., a sculptable material based on the polymer polyvinyl chloride) or the like. The malleable material 52 could be white in color to resemble a human eye lens that has a cataract (e.g., the cataract generally shows as opaque discoloration in a human lens.) When assembling the artificial surgical practice media 50, the malleable material 52 could be rolled into a ball 58.

The polymer sheets 54 could be cellulose-based sheets such as those found in cellophane sheet rolls as found in many grocery stores and used for food preservation and the like. The tensile strength, thickness and texture of these types of cellophane sheets when generally brought taut generally gives a very realistic approximation of the capsule membranes (e.g., posterior and anterior) of the human eye (e.g., when being cut by a scalpel.)

The malleable material 52 could be rolled into a disc or ball 56. One polymer sheet 54 could be stretched over the unattached open end 44 of the column 32 with the excess sheet material being wrapped down the sides of the column 32. A depression 58, such as formed by an insertion of the operator's thumb (not shown) in to the one polymer sheet 54, could receive and generally hold the ball 56. The one polymer sheet 54 could simulate the posterior capsule membrane. The other polymer sheet 54 could then be stretched over the ball 56, one polymer sheet 54 and down the sides of the column 34 to generally simulate an anterior capsule membrane.

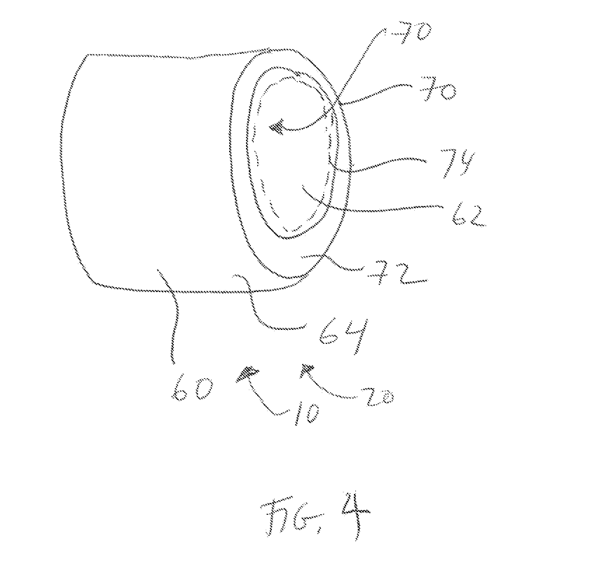

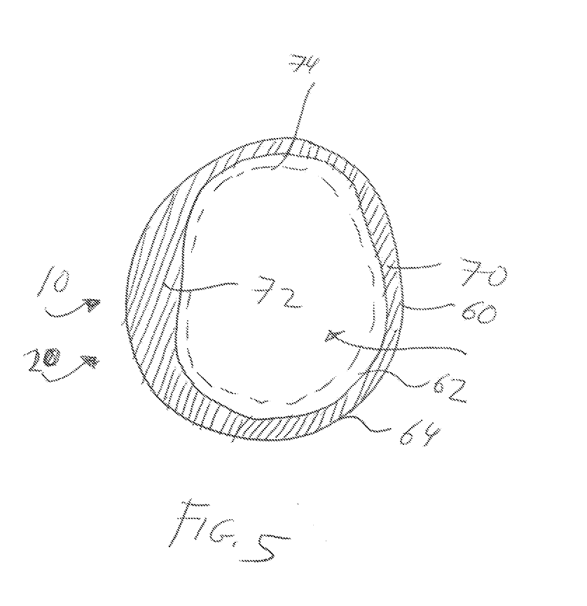

As substantially shown in FIGS. 4 and 5, the retaining ring 60 can have an interior wall 62, an exterior wall 64, and ring apertures 66, wherein the interior wall 62 further generally denotes a hollow interior 68 continuously connecting two ring end apertures 66. The circumference 74 of the internal wall 62 may be of sufficient size to substantially allow the retaining ring 60 to generally be placed over the column 32 (e.g., substantially receive the column 32 into the hollow interior 58.) As the polymer sheets 54 of the artificial surgical practice media 50 are wrapped around the column 32 to generally locate and hold the malleable material 52 over/within the unattached open end 44, this action results in folds of variable thickness of polymer sheets that occurs between the column 32 and the retaining ring 60. The retaining ring 60 can be designed to accommodate this variation.

One version of the retaining ring 60 could be made from resilient material such ¾ inch diameter PVC pipe and be bored on an ordinary engine lathe (not shown.) When the retaining ring 60 is secured within the lathe, the lathe's chuck is over-tightened against the retaining ring 60 causing the retainer ring 60 to distort. The lathe is then activated to bore the retaining ring 60 into a distorted condition. The resulting bored hole/interior circumference is round/circular until the retaining ring 60 is removed from the lathe and retaining ring 60 returns to its natural (non-deformed) shape. This natural shape results in a thin spot(s) 70 within the interior wall 62 of the retaining ring 60 where each of the jaws on the lathe chuck contacted the retaining ring 60. These thin spots 70 result in corresponding lobes 72 or thicker sections of the retaining ring interior wall 62. This lobed shape causes the retaining ring 60 to act as a spring to reversibly yet securely hold the polymer sheets 54 taut as wrapped around the column 32.

In another embodiment (not shown), the retaining rings 60 could be molded or extruded into an offset concentricity (lobed format). In still another embodiment (not shown), one version of the retaining ring 60 could be to make it fully elastic (e.g., a rubber band.) In still yet another embodiment (not shown), one version of the retaining ring could have a concentric hollow interior 68 but further has a groove in the interior wall 62 that holds an elastic O-ring that can compress the pair of polymer sheets 54 tautly against the column 32.

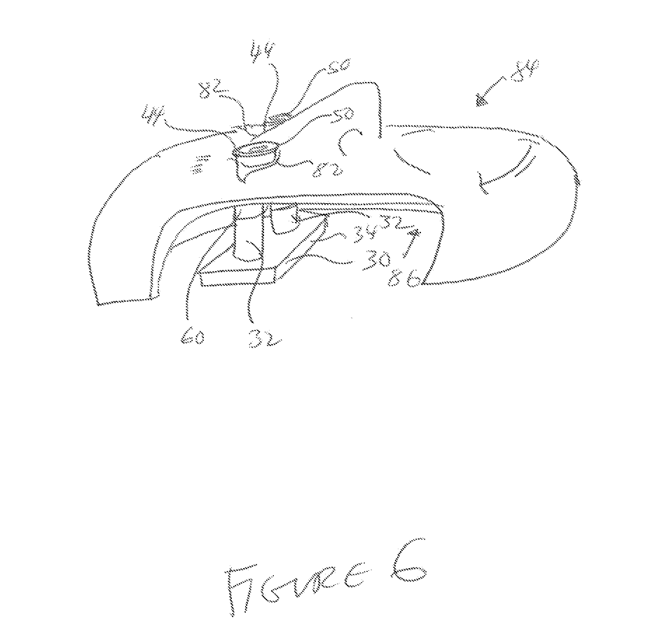

As substantially shown in FIG. 6, one possible embodiment of the invention 10 could further comprise of a mask 80 (e.g. vacuum-formed) resembling a human face having a pair of eye apertures 82. The eye apertures 82 could continuously connect the front side 84 and back side 86 of the mask 80. For this embodiment, the base 34 could support two columns 32 in an upright, spaced-apart parallel orientation to one and other. The back side 86 of the mask 80 could be placed over the media holder 30 so that an unattached open end 44 could protrude through a respective eye aperture 82 to provide the cataract surgical trainer with more realistic human face simulation.

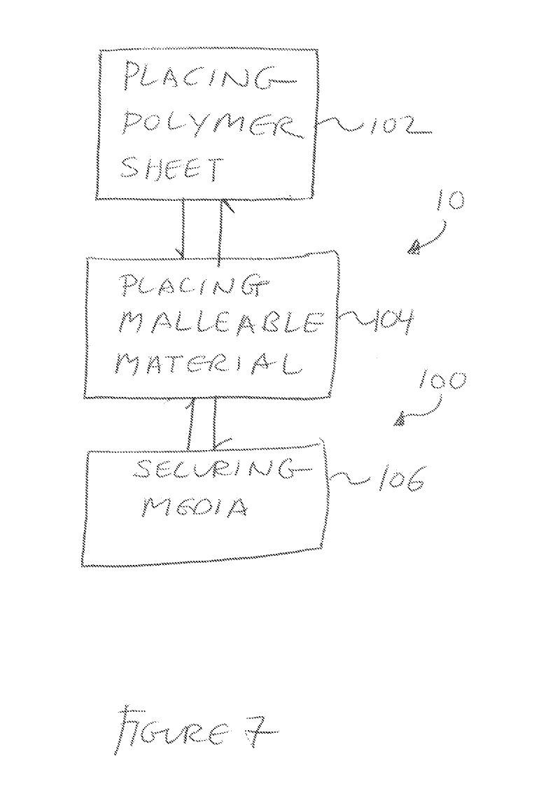

As substantially shown in figure shown in FIG. 7, one possible embodiment of the invention could be a process 100 of assembling or constructing the invention. This process 100 could start with step 102, placing one polymer sheet. In this step, one polymer sheet could be placed over the column to cover the unattached open end of the column. The remainder of the one polymer sheet could be wrapped down around the column (e.g., generally forming a realistic simulation of the posterior capsule membrane.) The operator could then push its thumb down upon the one polymer sheet that is over the unattached open end to create a depression that could accommodate the ball of malleable material (e.g., forming the simulated cataract lens.) As this step is completed, the process 100 could proceed to step 104, placement of malleable material and other polymer sheet.

In step 104, placement of malleable material and other polymer sheet, the malleable material is rolled into a ball that is subsequently placed in the formed depression. The other polymer sheet could then be placed over the ball and one polymer sheet to drape down over the top and sides of the column. As the wrapping of the two polymer sheets is pulled down upon the column to bring the polymer sheets is taut over the column to realistically simulate the capsule membranes, the sandwiching action of the two polymer sheets may force the ball into a realistic simulation of the cataract lens. As this step is substantially completed, the process 100 may proceed to step 106, securing the artificial surgical practice media.

In step 106, securing artificial surgical practice media, the retaining ring can be placed over the two polymer sheets and the column (or conversely, the two polymer sheets as wrapped about the column and the column/polymer sheets can be reversibly received within the retaining ring.) In one possible embodiment, as the retaining ring moves from its un-deformed, non-concentric shape as it receives the column with the wrapped-around polymer sheets to move into its deformed concentric shape, the retaining ring acts as a spring upon the column/polymer combination to compress/constrict the polymer sheets against the side of the column. In yet another possible elastic embodiment, the retaining ring (e.g., a rubber band) having its circumference expanded to encompass the column/wrapped around polymer sheets and is then released to snuggly and tautly hold the polymer sheets to relative to each other, malleable material, and the column. In other embodiments of the invention, other means of securing the artificial surgical practice media means to the media holder may be utilized instead of the retaining ring. These other means may include adhesives, threaded connectors, slip fittings, press fittings, compression fittings, wire ties, rubber bands, O-rings, clamps and the like.

In those versions of the invention feature a mask, a single base that supports upright two columns, and two sets of the artificial surgical practice media. Once the artificial surgical practice media has been attached its respectively column, the mask can be lowered over the base/columns so that each eye aperture of the marks reversibly receives the artificial surgical practice media/unattached open end to provide a more realistic surgical training simulation of a human face with cataracts.

As this step is substantially completed, the assembly of the invention is generally seen as finished. The invention can now be used for its intended purpose of allowing the health care professional to practice making those surgical incisions and other activities to removing and replacing a cataract lens (e.g., the malleable material) from between the anterior and posterior capsule membranes (e.g., the polymer sheet sandwich) without having to hold the invention in place by hand. Once the health care professional has finished its practicing (e.g., successfully or unsuccessfully removing the cataract), the process 100 can be reversed to remove the used artificial surgical practice media. The process can then be repeated to re-prep the invention 10 by attaching new artificial surgical practice media to the column(s) to allow continued surgical practice on the invention 10 as needed.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

As described and shown, the invention is apparatus and method of construction for a cataract surgical trainer that uses easily obtained artificial surgical practice media that is easily attached to a media holder which can be incorporated into a human mask. The media can be easily, quickly and cheaply replaced to allow continued economic use of the trainer. The trainer can stand by itself and holds the polymer sheets taunt thus allowing the medical professional to use both hands while practicing the cataract surgical technique.

What is claimed is:

1. A surgical cataract trainer comprising:
a) an artificial surgical practice media formed from malleable material and two polymer sheets;
b) a media holder comprising of a base and at least one column with two ends, the base attaches to one end while the other unattached end is open and can receive at least a portion of the artificial surgical practice media;
c) a retaining ring;
wherein one polymer sheet is stretched over the open end to support the malleable material within the open end as the other polymer sheet drapes over the malleable material, the one polymer sheet and the column to sandwich the malleable material between the two polymer sheets, the retaining ring is placed over the two polymer sheets and an outside of the column to make the polymer sheets taut relative to the unattached open end.

2. The surgical cataract trainer of claim 1 wherein the base holds the column in an upright position.

3. The surgical cataract trainer of claim 1 wherein the base supports two columns in upright, parallel and spaced-apart orientation.

4. The surgical cataract trainer of claim 3 further comprising a mask resembling a human face, the mask further having two eye apertures, each eye aperture continuously connecting a front side and a back side of the mask.

5. The surgical cataract trainer of claim 4 wherein the mask is placed over the two columns to allow their open ends to protrude through respective eye apertures.

6. The surgical cataract trainer of claim 1 wherein the retaining ring has lobes that press upon the polymer sheets when the ring receives the two polymer sheets and the column.

7. The surgical cataract trainer of claim 1 wherein the retaining ring has a non-circular cross-section that when the retaining ring is placed upon the column causes the retaining ring to deform and to have a cross-section that is more circular than a cross section of a non-deformed retaining ring when the non-deformed retaining ring is not located upon the column.

8. The surgical cataract trainer of claim 1 wherein the ring is deformed when placed upon the column to exert pressure upon the two polymer sheets wrapped about the column to hold the sheets in place upon the column.

9. The surgical cataract trainer of claim 1 wherein the retaining ring is created to allow the retaining ring to compress the polymer sheets against the column.

10. The surgical cataract trainer of claim 1 wherein the column is constructed from definite section of ½ inch diameter polyvinyl chloride pipe and the retaining ring is constructed from a definite section of ¾ inch diameter polyvinyl chloride pipe.

11. The surgical cataract trainer of claim 1 wherein as the ring pulls the polymer sheets taut on the column, the polymer sheets then realistically simulate a posterior capsule membrane and an anterior capsule membrane of the human eye.

12. The surgical cataract trainer of claim 1 wherein the malleable material is modeling clay.

13. The surgical cataract trainer of claim 1 wherein the polymer sheets are made from cellophane.

14. A process for constructing a cataract surgical trainer comprising of the following steps, but not necessarily in the order shown:
a) providing an artificial surgical practice media of a malleable material and two polymer sheets;
b) providing a media holder of a base and a column with two ends, the base attaching to one end while the other unattached end is open and can receive at least a portion of the artificial surgical practice media;
c) providing a retaining ring;
d) placing one polymer sheet over the open end;
e) creating a depression in the one polymer sheet within the open end;
f) placing the malleable material into the depression;
g) draping the other polymer sheet over the malleable material, the one polymer sheet and the column causing the malleable material to be sandwiched between the two polymer sheets; and
h) placing the retaining ring over the column and two polymer sheets to hold the malleable material tautly between the two polymer sheets.

15. A process of claim 14 further comprising of a step of locating the base to position the media holder in an upright position.

16. A process of claim 14 further comprising of a step of holding the malleable material distal from the base.

17. The process of claim 14 further comprises of a step of deforming the ring.

18. The process of claim 17 wherein the step of deforming the ring further comprises a step of applying a retaining force against the polymer sheets to hold them in place tautly against the open end.

19. The process of claim 18 wherein the step of applying a retaining force against the polymer sheets further comprises a step of creating a realistic simulation of posterior capsule membrane of the human eye.

20. The process of step 14 further comprising the step of providing a human mask with eye apertures through which protrude unattached open ends of the columns.
